(19) United States
(12) Patent Application Publication
(10) Pub. No.: US 2007/0235899 A1
(43) Pub. Date: Oct. 11, 2007

(54) Dimple Forming Process for Stent Deployment Balloon

(75) Inventor: Tony O'Halloran, Ballybrit (IE)

Correspondence Address: MEDTRONIC VASCULAR, INC.;IP LEGAL DEPARTMENT, 3576 UNOCAL PLACE, SANTA ROSA, CA, 95403, US

(73) Assignee: Medtronic Vascular, Inc., A Delaware Corporation, Santa Rosa, CA (US)

(21) Appl. No.: 11/278,177

(22) Filed: Mar. 31, 2006

(51) Int. Cl. B28B 3/02

(52) U.S. Cl. 264/319

(57) ABSTRACT

A method for constructing stent retention features on a pre-formed stent deployment balloon includes folding the pre-formed balloon into a folded configuration for subsequently retaining an undeployed stent. The balloon is then inserted in the folded configuration into at least one sheath defining a pattern of openings. The balloon is then heated and pressurized to force exterior portions of the balloon into the openings and thereby form protruding stent retention features as part of the balloon. A stent may then crimped around the balloon in the folded configuration.

### TECHNICAL FIELD

The present invention generally relates to intravascular stent delivery and deployment catheters, and more particularly to a stent deployment device that is equipped with retention members for retaining a stent on a balloon during insertion and/or retraction of the stent.

### BACKGROUND

In a typical percutaneous transluminal coronary angioplasty (PTCA) procedure, a guiding catheter is percutaneously introduced into the cardiovascular system of a patient. The guide catheter is advanced through a vessel until the distal end thereof is at a desired location in the vasculature. A guide wire and a dilatation catheter having a flexible and expandable balloon on the distal end thereof are introduced into the guiding catheter with the guidewire sliding through the dilatation catheter. The guide wire is first advanced out of the guiding catheter into the patient's coronary vasculature, and the dilatation catheter is then advanced over the previously advanced guide wire until the dilatation balloon is properly positioned across the lesion. Once in position, the preformed balloon is inflated to a predetermined size with a liquid or gas at relatively high pressure (e.g. about ten to twelve atmospheres) to radially compress the arthrosclerotic plaque in the lesion against the inside of the artery wall and thereby dilate the lumen of the artery. The balloon is then deflated to a small profile so that the dilatation catheter may be withdrawn from the patient's vasculature and blood flow resumed through the dilated artery.

Restenosis may occur in an artery following PTCA or other angioplasty procedure. Restenosis is a re-narrowing of the treated coronary artery that is related to the development of neo-intimal hyperplasia within the artery in response to mechanical intervention within a vascular structure. To prevent restenosis and strengthen the treated vascular area, an intravascular prosthesis generally referred to as a stent may be implanted for maintaining vascular patency inside the artery at the lesion. The stent is mounted in a pre-deployment or compressed state around a deflated balloon, and the balloon/stent assembly is maneuvered through a patient's vasculature to the site of a target lesion. The stent is then expanded to a larger diameter for implantation in the vasculature. The stent effectively overcomes the natural tendency of the vessel walls of some patients to close back down, thereby maintaining a normal flow of blood through the vessel that would not be possible if the stent was not in place.

One type of expandable stent that is delivered on a balloon catheter is a metallic steel cylinder having a number of openings in its circumference. The array of openings in the stent produces scaffolding when the device is expanded. The metallic steel cylinder is compressed onto an exterior surface of a non-expanded balloon that is attached to a catheter distal end region. Unfortunately, the stent is not always sufficiently secured to the balloon to ensure that the stent will properly stay in place while advancing the stent to and through a target lesion. Additionally, the outer surface of the delivery device may be uneven because the stent generally extends radially outwardly beyond the balloon exterior surface. Thus, the stent may contact a vessel wall and be displaced as the catheter negotiates a narrow vessel.

For example, the guide catheter may be inserted through the abdominal aorta to a point just beyond the ostium from which the right coronary artery and the left main artery diverge. Blockages or lesions may form in smaller coronary vessels, and there may be occasions when the balloon/stent catheter cannot be properly positioned within the target area due to the constriction of a vessel. Even if predilatation is performed prior to stent engagement, vascular spasms and/or re-closure of the vessel may occur and create difficulty when aligning the balloon/stent assembly. In addition, a lesion may be heavily calcified, requiring a high insertion pressure, which may result in unwanted displacement of the compressed stent.

Accordingly, it is desirable to provide a low profile stent delivery and deployment apparatus that includes features for improving the retention force acting on a compressed stent that is formed around a balloon. In addition, it is desirable to provide efficient and effective methods for manufacturing and using such a deployment apparatus. Furthermore, other desirable features and characteristics of the present invention will become apparent from the subsequent detailed description and the appended claims, taken in conjunction with the accompanying drawings and the foregoing technical field and background.

### BRIEF SUMMARY

A method is provided for constructing stent retention features on a pre-formed stent deployment balloon. The pre-formed balloon is folded into a folded configuration for subsequently retaining an undeployed stent. The balloon is then inserted in the folded configuration into at least one sheath defining a pattern of openings. The balloon is then heated and pressurized to force exterior portions of the balloon into the openings and thereby form protruding stent retention features as part of the balloon. According to another embodiment, a stent is then crimped around the balloon in the folded configuration.

### BRIEF DESCRIPTION OF THE DRAWINGS

The present invention will hereinafter be described in conjunction with the following drawing figures, wherein like numerals denote like elements, and

FIG. 1 is a perspective view of a balloon catheter assembly, including an inflatable balloon, an elongate flexible and tubular shaft, and a hub;

FIG. 2 is a longitudinal cross sectional view of a catheter shaft distal end;

FIG. 3 is a cross sectional view depicting a stent and a balloon around a guidewire lumen, taken along line 3-3 in FIG. 2;

FIG. 4 is a perspective view depicting a sheath used to form stent retaining dimples in a pre-formed balloon according to an exemplary embodiment;

FIG. 5 is a side view of a sheath receiving a folded balloon to form stent retaining dimples thereon according to an exemplary method;

FIG. 6 is a block diagram depicting an exemplary method for manufacturing a stent deployment balloon;

FIG. 7 is a perspective view of an exemplary heating block for forming stent retaining dimples in a pre-formed balloon;

FIG. 8 is a perspective view of an exemplary balloon mounted on a shaft distal end, the balloon having substantially hemispherical-shaped dimples;

FIG. 9 is a perspective view of an exemplary balloon mounted on a shaft distal end, the balloon having substantially ring-shaped dimples;

FIG. 10 is a cross-sectional view of a balloon mounted on a shaft distal end and disposed inside inner and outer sheaths for forming ring-shaped dimples on the balloon; and

FIG. 11 is a perspective view of a plurality of inner sheaths for forming ring-shaped dimples on a balloon.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

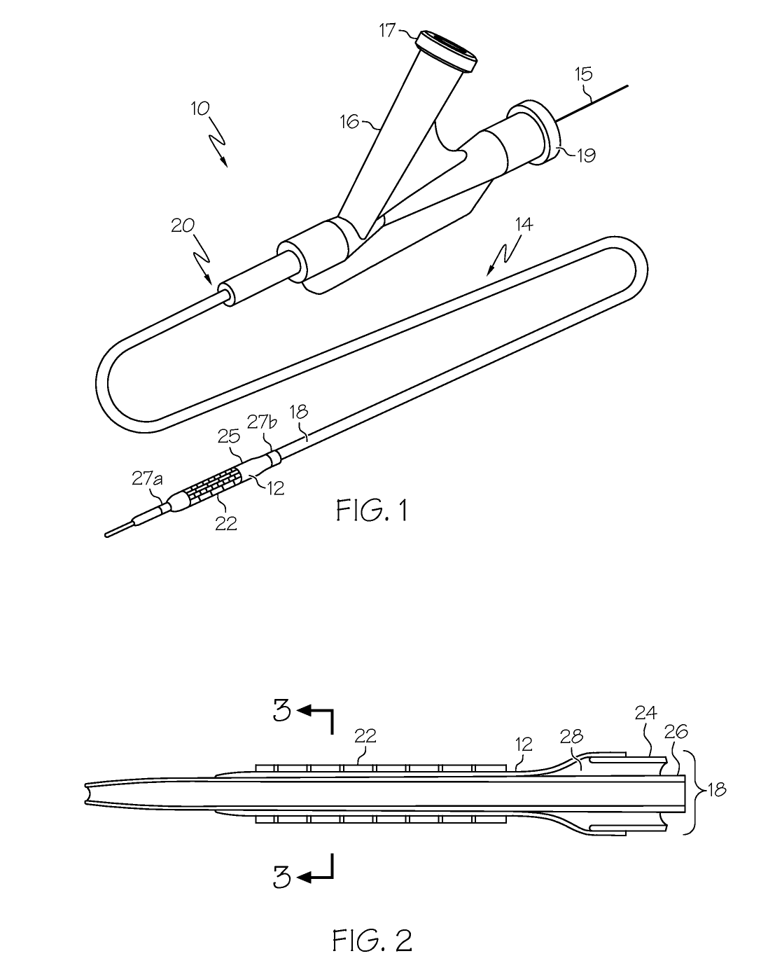

FIG. 1 is a perspective view of a balloon catheter assembly 10, including an inflatable balloon 12, an elongate flexible and tubular shaft 14, and a hub 16. The balloon 12 is affixed to the shaft 14 near the shaft distal end 18, and the hub 16 is affixed to the shaft proximal end 20. A stent 22, depicted in a compressed and deployable state, is formed around the balloon 12.

The shaft 14 defines one or more passages or lumens extending therethrough, at least one of which is an inflation lumen that is connected to and in fluid communication with both the balloon and the hub for the purpose of selectively inflating and deflating the balloon. FIG. 2 is a longitudinal cross sectional view of the shaft distal end 18, which includes an outer inflation lumen 26 that surrounds an inner guidewire lumen 26. The inflation lumen 26 receives a fluid from the hub 16 at the proximal end for connecting the inflation lumen 26 to a source of pressurized fluid (not depicted) in a conventional manner. The hub 16 includes an inflation port 17 and a guidewire port 19 with a luer-lock fitting, hemostatic valve, or other coupling that facilitates guidewire traversal within the guidewire lumen 26 while preventing the loss of blood or other fluids through the guidewire lumen and guidewire port. The inflation lumen 26 facilitates transfer of the fluid to the balloon interior 28 for selectively inflating and deflating the balloon 12. The guidewire lumen 26 is adapted to receive an elongated flexible guidewire 15 in a sliding fashion, enabling the guidewire 15 and the catheter shaft 14 to be independently advanced or withdrawn.

The stent 22 is an expandable device made from a biocompatible material such as stainless steel, or a cobalt chromium alloy, or a bioabsorbable material and may be sized and configured as suitable for its intended placement, function, and so forth. The stent 22 depicted in the drawings is a cylindrical metal mesh having an initially crimped configuration, which may be forcibly expanded by the balloon 12 to a deployed configuration. In the crimped configuration, the stent has a smaller outer diameter than in the deployed configuration. When deployed in a body passageway, the stent 22 may be designed to press radially outward against a passageway wall to prevent the passageway from closing.

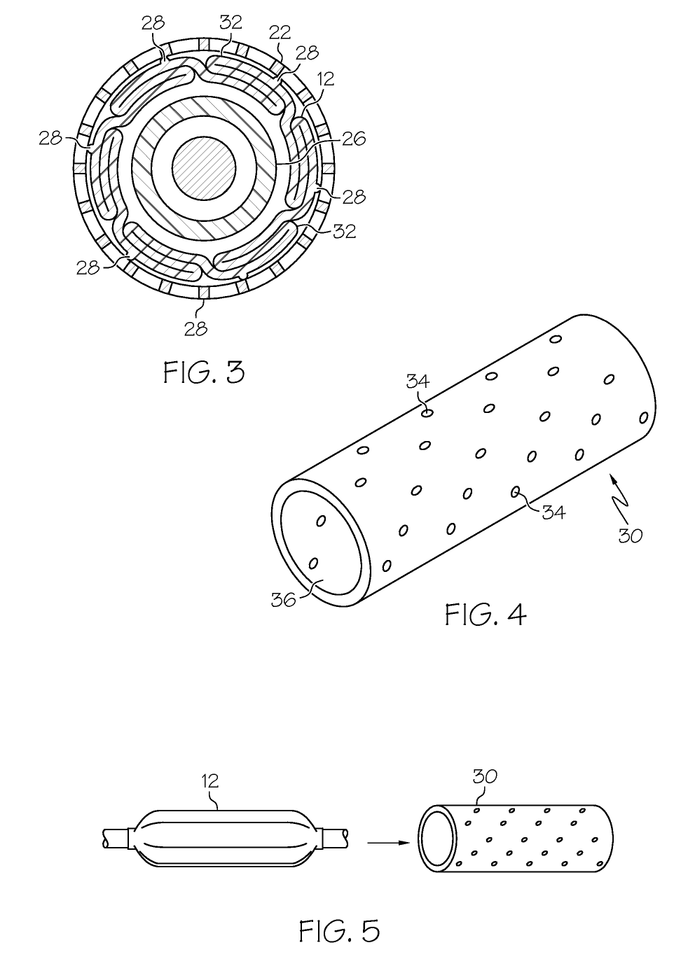

FIG. 3 is a cross sectional view depicting the stent 22 and balloon 12 around the guidewire lumen 26 along line 3-3 in FIG. 2. The balloon 12 is depicted in a deflated state, and the stent 22 is consequently compressed around the balloon 12. As depicted in FIG. 1, the balloon 12 has an expandable portion 25 located between a pair of proximal and distal end portions 27a and 27b that are affixed to the shaft distal end 18. More particularly, in the depicted embodiment the distal end portion 27a is affixed to the guidewire lumen 26, and the proximal end portion 27b is affixed to the inflation lumen 24. The expandable portion 25 is inflatable to an enlarged diameter when fluid is received from the inflation lumen 24, and to thereby expand the stent 22 and press it radially outward against a passageway wall. According to an exemplary configuration, the balloon has several pleats 32 that are wrapped around the shaft when the balloon 12 is in a deflated state as depicted in FIG. 3. The balloon material is substantially inelastic, and stretches a relatively small amount under operating pressures. Although many materials may be used to form the balloon 12, some exemplary materials include nylon, HDPE, PEEK, PEBAX, or a block copolymer thereof

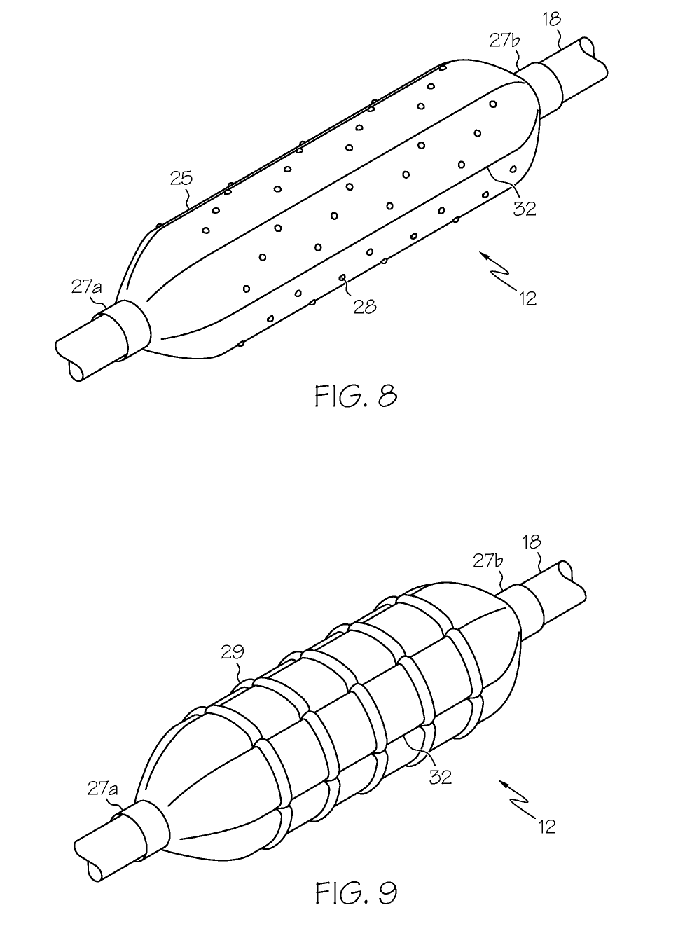

The balloon 12 includes substantially hemispherical-shaped dimples 28 protruding outwardly to frictionally engage with the stent 22. Consequently, the dimples 28 are formed in the balloon's expandable portion 25 on which the stent 22 is supported, and not on the distal or proximal end portions 27a and 27b. The dimples 28 are formed in a pattern on the overlapping pleats 32, the pattern being determined by an arrangement of holes in a mold as will be subsequently described in detail. Turning briefly to FIGS. 8 and 9, two exemplary balloons 12 with differently shaped stent retention protrusions are depicted. In both figures, the balloon 12 is depicted being mounted on a shaft distal end 18, without a stent disposed around the balloon 12. FIG. 8 is a perspective view of the balloon 12, mounted on the shaft distal end 18, having the previously-described, substantially hemispherical-shaped dimples 28. The dimples 28 are arranged in a helical pattern in order for the dimples 28 to be regularly and evenly positioned for optimal stent retention. FIG. 9 is a perspective view of the balloon 12 having protruding circular ribs 29 formed as rings around the balloon circumference when the balloon. In both embodiments, the protrusion patterns are evident when the balloon 12 is folded such that the protrusions are only formed on the outwardly exposed portions of the overlapping pleats 32.

As previously discussed, the balloon 12 may not provide a sufficient friction force on the stent 22 to ensure that the stent 22 will properly stay in place while being advanced to and through a target lesion. The stent 22 may have a larger outer diameter than the balloon 12, imparting an uneven surface to the overall balloon region. Thus, the stent 22 may contact a vessel wall and be displaced as the catheter negotiates a narrow vessel. The protruding dimples 28 formed on the balloon 12 create a sufficiently strong friction force on the stent 22 to maintain its placement through a patient's tortuous vasculature. Dimensions such as the overall width and height for the dimples 28 will vary depending on factors that may include the stent dimensions, the type of procedure for which the stent 22 will be employed, the balloon material, and the balloon configuration with respect to the stent 22.

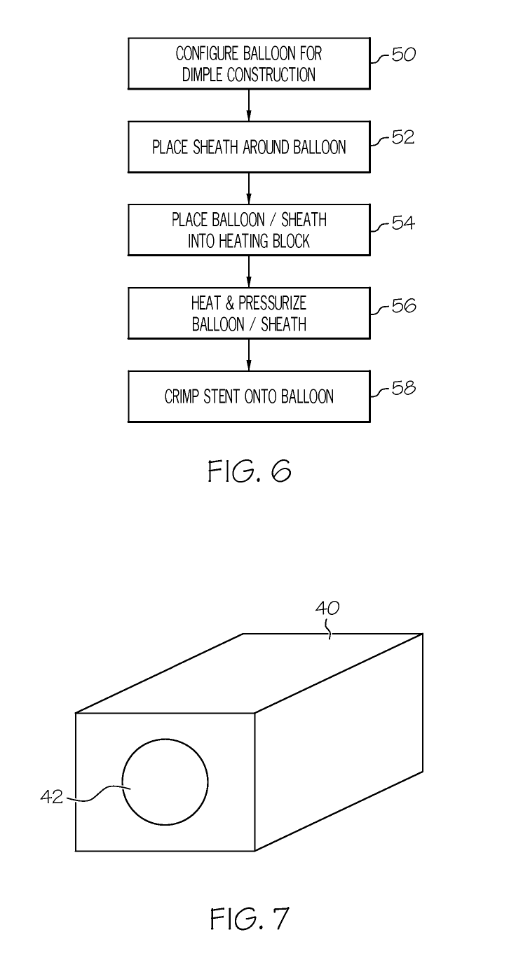

Turning now to FIG. 6, a block diagram depicting an exemplary method for forming stent retaining dimples in the pre-formed stent deployment balloon 12 is outlined. Beginning with step 50, a pre-formed balloon 12 is prepared for dimple construction by arranging the balloon material in a configuration whereby dimples will be formed in regions that will be beneficial for stent retention. The balloon is pre-formed in the sense that it has already been blow molded or otherwise formed. The balloon is also shaped, sized and otherwise adapted for attachment to a catheter distal end and for stent retention thereon. Also, the pre-formed balloon 12 may be wrapped in the manner depicted in FIG. 3, with a series of folds 32 overlapping one another. Other folding patterns may be performed as well. It is preferable to fold and to otherwise arrange the balloon 12 in a manner that represents the balloon configuration when it is subsequently coupled to the stent 22 so dimples will be formed in regions of the balloon 12 that will contact the stent 22.

Some prior art dimple forming methods attempt to include incorporate dimples or other stent retention features while the balloon itself is being initially molded or otherwise formed. This results in dimples being formed over many regions that will eventually be covered by overlapping folds or pleats in the balloon. In contrast, the present method includes folding and otherwise arranging the balloon 12 to the configuration it will ultimately resemble while retaining the un-deployed stent 22. After folding the balloon, dimples will be formed only in those outwardly exposed areas of the folds or pleats 32 that will contact the stent 22. Thus, dimples are not folded onto other dimples according to the present method, but non-dimpled regions are folded onto non-dimpled regions, and dimples are only formed on non-overlapping balloon regions.

In an exemplary embodiment, the balloon 12 is also configured for dimple formation by attaching the balloon 12 to the shaft distal end 18. More particularly, the balloon 12 is attached in the manner depicted in FIG. 1, without the stent 22 formed around the balloon 12. The balloon proximal end 27b is attached to the inflation lumen 24, and the balloon distal end 27a is attached to the guidewire lumen 26. The balloon is then folded as desired, or may be folded prior to being attached to the shaft distal end 18.

After configuring the balloon 12, a sheath is placed around the balloon's expandable portion 25 as step 52. FIG. 4 is a perspective view depicting an exemplary sheath 30, and FIG. 5 is a side view of the sheath 30 receiving the folded balloon 12. The sheath 30 is a cylindrical body having a hollowed entrance 36 for receiving the balloon 12. Holes 34 are formed through the sheath 30 in a pattern that establishes the dimple pattern to be constructed on the balloon 12. An exemplary sheath includes holes in a helical pattern as depicted in FIGS. 4 and 5, to produce the balloon 12 depicted in FIG. 8.

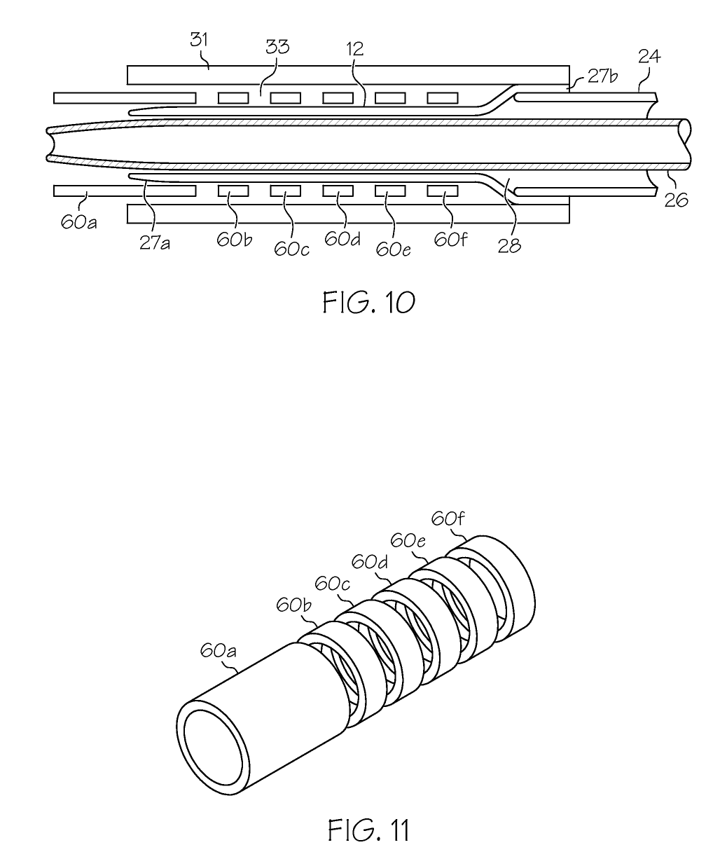

There are numerous dimple patterns that may be formed in the balloon 12 by arranging the array of holes 34 in the sheath 30 as desired. Further, the holes 34 need not be round. For example, instead of forming hemispherical dimples on the balloon 12, it may be desirable to form elongate ribs along the balloon folds 32 instead of hemispherical dimples. The holes 34 in such an embodiment would be elongate openings. As previously discussed, the balloon 12 depicted in FIG. 9 includes circular ribs 29 formed as rings around the balloon circumference when the balloon 12 is folded. FIG. 10 is a cross-sectional view of another exemplary outer sheath 31 that is essentially a cylinder, and that surrounds a plurality of inner sheaths 60a-f. The inner sheaths 60a-f are substantially cylindrically shaped members that have smaller lengths and diameters than the outer sheath 31, and are depicted in a perspective view in FIG. 11. Together, the plurality of inner sheaths 60a-f form ring-shaped ribs 29 on the balloon 12. The inner sheaths 60a-f are entirely separate from the outer sheath 31, but may be joined to the outer sheath 31 according to another embodiment. Other possible hole patterns in a sheath may include combinations of round and elongate dimples, or dimples having various geometrical shapes as determined by the hole shapes and patterns formed in the sheath.

Once the balloon 12 is inserted into a sheath, the coupled sheath and balloon are placed into a heating block as step 54. FIG. 7 is a perspective view of an exemplary heating block 40 that may be used in the present method. The block 40 includes an opening 42 that is sized to receive and contain the sheath. Next, the balloon 12, together with the sheath, is heated and pressurized while disposed in the heat block 40. The temperature and pressure are adjusted depending on various factors including the balloon material, the desired height of the dimples being formed. The balloon 12 and sheath 30 may be heated by flowing hot air into through the block 40. Alternatively, the block 40 itself may be electrically heated, i.e. by conduction and resistance, in which case radiated heat from the block 40 will heat the balloon 12 and sheath. The heat softens the balloon material, while the pressure forces portions of the balloon folds into adjacent holes 34. Pressure is applied to the balloon 12 by applying a fluidic or pneumatic pressure to the balloon interior while heating the balloon 12.

In an exemplary embodiment, the balloon 12 is attached to the shaft distal end 18 as depicted in FIG. 10 during the dimple forming process. Air or other fluid is then blown into the balloon interior by means of the inflation lumen 24 while heating the balloon to form the dimples. Upon cooling, the heat-softened balloon material sets with permanently constructed dimples 28 formed in a pattern representing the array of holes 34. The balloon 12 having the dimples formed thereon, is removed from the sheath by simply peeling the flexible balloon material away from the sheath inner surface.

As step 58, the constructed balloon 12 is coupled to the stent 22 by sliding the stent 22 onto the balloon's expandable portion 25. The stent 22 engages at least with the dimples 28 on the balloon 12 and is thereby longitudinally retained in position and prevented from slipping when the catheter 14 advances through a passageway such as a patient's vasculature.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method of constructing stent retention features on a pre-formed stent deployment balloon, comprising:
folding the pre-formed balloon into a folded configuration for subsequently retaining an undeployed stent;
inserting the pre-formed balloon in the folded configuration into at least one sheath defining a pattern of openings;
heating and pressurizing the balloon to force exterior portions of the balloon into the openings and thereby form protruding stent retention features as part of the balloon.

2. The method of claim 1, wherein in the folded configuration, the balloon comprises a plurality of overlapping folds having exposed outer portions and unexposed overlapping portions.

3. The method of claim 2, wherein the protruding stent retention features are only formed as part of the exposed outer portions.

4. The method of claim 1, wherein heating and pressurizing the balloon is performed with the balloon and sheath in a heating block.

5. The method of claim 4, wherein heating the balloon comprises flowing heated gas through the heating block.

6. The method of claim 4, wherein heating the balloon comprises conductive heating the heating block.

7. The method of claim 1, wherein the openings are formed in a helical pattern through the at least one sheath, and the step of heating and pressurizing the balloon forms stent retention features in a helical pattern.

8. The method of claim 1, wherein the at least one sheath comprises a plurality of cylindrical members spaced apart to define the openings therebetween, and the step of heating and pressurizing the balloon forms stent retention features as ring shaped ribs.

9. The method of claim 1, further comprising:
attaching the balloon to a catheter distal region before inserting the balloon in the folded configuration into the sheath.

10. The method of claim 9, wherein upon attaching the balloon to the catheter distal region, an inflation lumen of the catheter is in communication with an interior region of the balloon, and pressurizing the balloon comprises applying pneumatic or fluidic pressure to the balloon through the inflation lumen.

11. A method of manufacturing a stent deployment device, comprising:
folding a pre-formed balloon into a folded configuration;
inserting the balloon in the folded configuration into a sheath having a pattern of holes formed therein;
heating and pressurizing the balloon to force exterior portions of the balloon into the holes and thereby form stent retention features as part of the balloon; and
crimping a stent around the balloon in the folded configuration.

12. The method of claim 11, wherein in the folded configuration, the balloon comprises a plurality of overlapping folds having exposed outer portions and unexposed overlapping portions.

13. The method of claim 12, wherein the protruding stent retention features are only formed as part of the exposed outer portions.

14. The method of claim 11, wherein heating and pressurizing the balloon is performed with the balloon and sheath in a heating block.

15. The method of claim 14, wherein heating the balloon comprises flowing heated gas through the heating block.

16. The method of claim 14, wherein heating the balloon comprises conductive heating the heating block.

17. The method of claim 11, wherein the holes are formed in a helical pattern in the sheath, and the stent retention features are formed in a helical pattern as part of the balloon.

18. The method of claim 11, wherein the at least one sheath comprises a plurality of cylindrical members spaced apart to define the openings therebetween, and the step of heating and pressurizing the balloon forms stent retention features as ring shaped ribs.

19. The method of claim 11, further comprising:
attaching the balloon to a catheter distal region before inserting the balloon in the folded configuration into the sheath.

20. The method of claim 19, wherein upon attaching the balloon to the catheter distal region, an inflation lumen of the catheter is in communication with an interior region of the balloon, and pressurizing the balloon comprises applying pneumatic or fluidic pressure to the balloon through the inflation lumen.
